(19) United States
(12) Patent Application Publication
(10) Pub. No.: US 2009/0089799 A1
(43) Pub. Date: Apr. 2, 2009

(54) PROGRAMMABLE LOGIC CONTROLLER WITH QUEUE FUNCTION AND METHOD FOR THE SAME

(76) Inventors: Jiun-Ru Tseng, Taoyuan Shien (TW); Hua-Yueh Hsu, Taoyuan Shien (TW)

Correspondence Address: HDLS Patent & Trademark Services, P.O. BOX 220746, CHANTILLY, VA, 20153-0746, US

(21) Appl. No.: 11/865,838

(22) Filed: Oct. 2, 2007

(51) Int. Cl. G06F 9/44; G06F 9/46

(52) U.S. Cl. 719/314; 718/103

(57) ABSTRACT

A programmable logic controller (PLC) with queue function and method for the same receives a first input command from one of plurality of operation ends by a command receiving/sending unit. The command receiving/sending unit judges whether the PLC is processing a command at that moment. The processor processes the first input command and sends back reply when there is no command under processing. When the processor is processing the first input command, the command-receiving unit places a second input command into a command queue and gives a priority setting to the second input command. When the PLC finishes its current task, the PLC further processes a command in the queue with highest processing priority. Therefore, the PLC processors can process every command from the operation ends in sequential manner.

### BACKGROUND OF THE INVENTION

1. Field of the Invention

The present invention relates to a programmable logic controller (PLC), especially to a programmable logic controller (PLC) with command queue to temporarily store command sent from operation ends.

2. Description of Prior Art

In factory automation field, the developing trends are to provide time-saving, effort-saving and automatic control. The conventional factory automation employs relay, button switch, timer, counter and sensing switch to provide automatic control. However, the controller for controlling the relay, button switch, timer, counter and sensing switch needs re-tailoring for new application. Therefore, programmable logic controller (PLC) is developed to provide more versatile control.

PLC has been extensively employed in industry for long time and allows the control command to load into therein anytime in a mechanical-and-electrical integration environment. Therefore, PLC can control the machine by input control command.

FIG. 1 shows a schematic view of operation for a conventional PLC 20 accessed by a plurality of operation ends 10. When one of operation ends 10 sends command to the PLC 20, the command is sent to the PLC 20 through the network bus 30. A command receiving/sending unit 202 in the PLC 20 receives the command and then sends the command to the PLC 20 for processing by a processor 201 therein. After finishing the process of command, the resulting reply is sent back to the original operation end 10. The above-described situation is suitable for the condition that only one operation end accesses the PLC 20. However, the commands have the risk of collision or loss when lots of operation ends want to access the PLC 20 nearly the same time. In this situation, the PLC 20 cannot process each command and reply each command with desired data to the operation end. In other word, the operation ends cannot effectively access the PLC 20 when lots of operation ends intend to access the PLC 20 at the same time.

### SUMMARY OF THE INVENTION

It is the object of the present invention to provide queue function to programmable logic controller (PLC). The un-processed commands are temporarily stored in the queue when the PLC is busy for current task. Therefore, each of the operation ends can obtain reply without data loss.

Accordingly, the present invention provides a programmable logic controller (PLC) with queue function and method for the same. The PLC with queue function first receives a first input command from one of plurality of operation ends by a command receiving/sending unit. The command receiving/sending unit judges whether the PLC is processing a command at that moment. The processor processes the first input command and sends back reply when there is no command under processing. When the processor is processing the first input command, the command-receiving unit places a second input command into a command queue and gives a priority setting to the second input command. When the PLC finishes its current task, the PLC further processes a command in the queue with highest processing priority. Therefore, the PLC processors can process every command from the operation ends in sequential manner.

### BRIEF DESCRIPTION OF DRAWING

The features of the invention believed to be novel are set forth with particularity in the appended claims. The invention itself however may be best understood by reference to the following detailed description of the invention, which describes certain exemplary embodiments of the invention, taken in conjunction with the accompanying drawings in which:

FIG. 1 shows a schematic view of operation for a conventional PLC.

FIG. 2 shows a block diagram of the PLC with queue function according to the present invention.

FIG. 3 shows the flowchart of the method of providing queue function for PLC according to the present invention.

FIGS. 4A to 4O demonstrate the operations of the method of providing queue function for PLC according to the present invention.

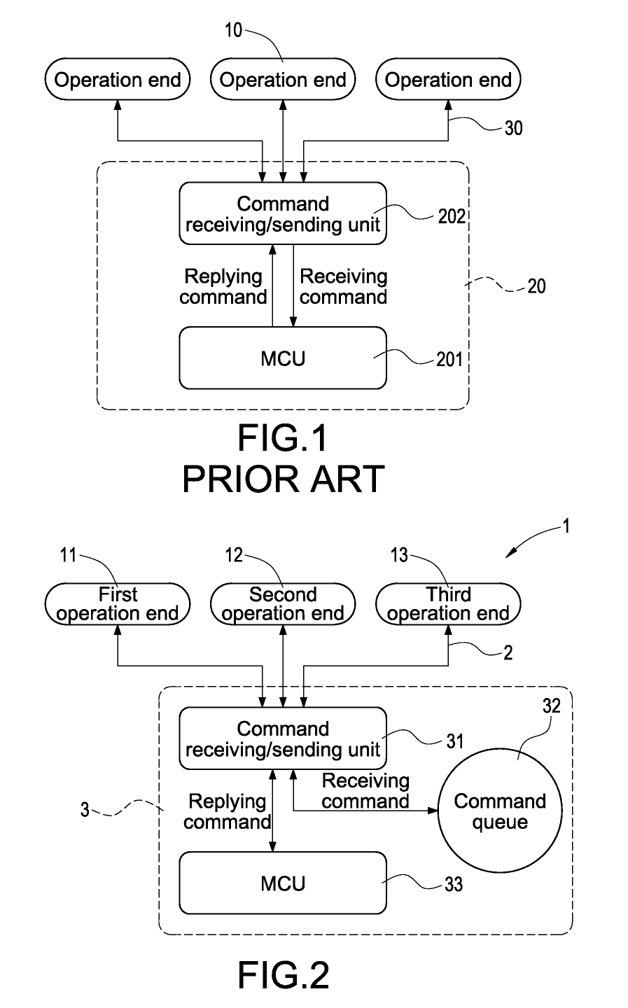

### DETAILED DESCRIPTION OF THE INVENTION

FIG. 2 shows a block diagram of the PLC with queue function according to the present invention. When a plurality of operation ends 1 intend to access the PLC 3 through Modbus TCP protocol, the commands from the operation ends 1 are stored in the queues 32 of the PLC 3 in first-in first-out manner. Therefore, the PLC 3 can sequentially access the commands fetched from the command queues 32 to prevent from data lost.

When a first operation end 11 sends a first command 111 to the PLC 3 through the network bus 2, the command receiving/sending unit 31 receives the first command 111. When there is other command processed by the PLC at that time, the command receiving/sending unit 31 stores the first command 111 in a command queue 32. When there is no command processed by the PLC at that time, the command receiving/sending unit 31 sends the first command 111 to the micro controller unit (MCU) 33 for processing therein. When the MCU 33 is processing the first command 111 or sending back the first reply associated with the first command 111, and the second operation end 12 is sending a second command 121 to the PLC 3, the command receiving/sending unit 31 stores the second command 121 in the command queue 32. After the first command 111 is processed and the first reply is sent back to the first operation end 11 through the network bus 2, the command queue 32 sends the second command 121 stored therein to the MCU 33 through the command receiving/sending unit 31, whereby the MCU 33 further processes the second command 121.

When the MCU 33 is processing the second command 121 or sending back the second reply associated with the second command 121, and the third operation end 13 is sending a third command 131 to the PLC 3, the command receiving/sending unit 31 stores the third command 131 in the command queue 32. After the second command 121 is processed and the second reply is sent back to the second operation end 12 through the network bus 2, the command queue 32 sends the third command 131 stored therein to the MCU 33 through the command receiving/sending unit 31, whereby the MCU 33 further processes the third command 131. In this way, the commands sent by the plurality of operation ends are processed in first-in first-out way. Therefore, all of the commands for the PLC can be processed fairly and correctly without data loss.

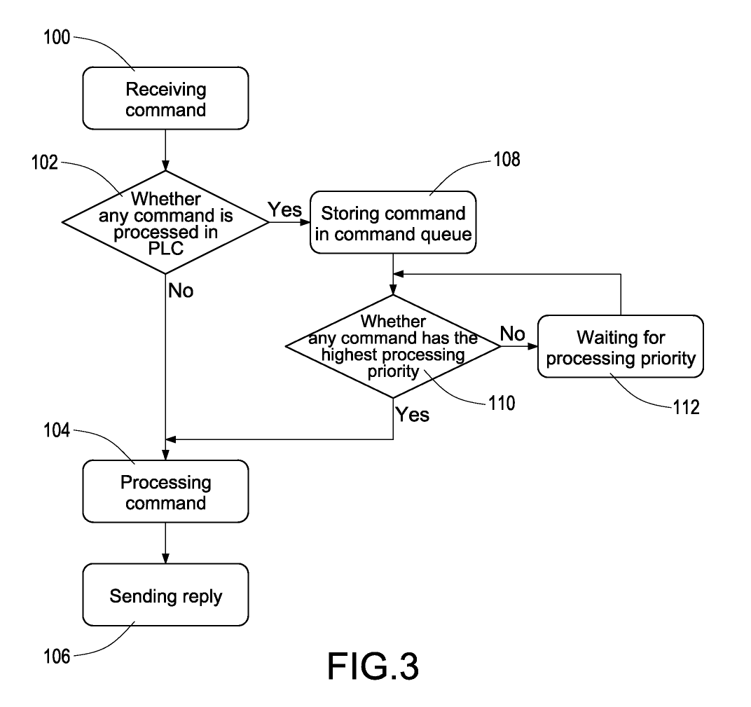

FIG. 3 shows the flowchart of the method of providing queue function for PLC according to the present invention. In step 100, the command receiving/sending unit 31 sequentially receives commands from the plurality of operation ends. In this demonstration, the first command 111 is first sent from the first operation end 11 and received by the command receiving/sending unit 31.

In step 102, the command receiving/sending unit 31 judges whether any command is processed by the MCU right now. If no command is processed in the MCU, then the newly received first command 111 is processed by MCU in step 104. Afterward, a first reply corresponding to the first command 111 is sent back to the first operation end 11 in step 106.

When the first command 111 is processed and a second command 121 is received in step 102, step 102 judges that there is still command processing by the MCU at that time. Therefore, the second command 121 is stored in the command queue in step 108. After the MCU finishes processing the first command 111, step 110 is performed to judge whether any command in queue has gained a highest processing priority, wherein the command with highest processing priority is a command at first position in command queue. In this case, the second command 121 gains processing priority in the command queue. When a command with priority to process, such as the second command 121, is identified, steps 104 and 106 are performed to process the second command 121. When no command has gained accessing priority in step 110, step 112 is performed to wait for command assigned with accessing priority.

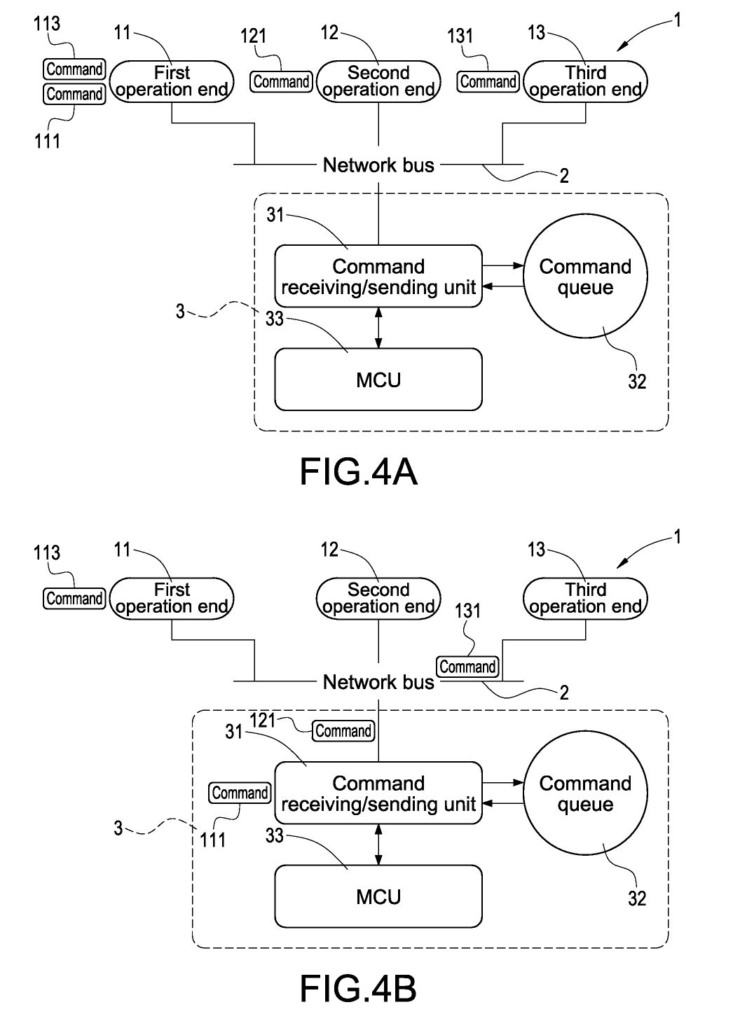

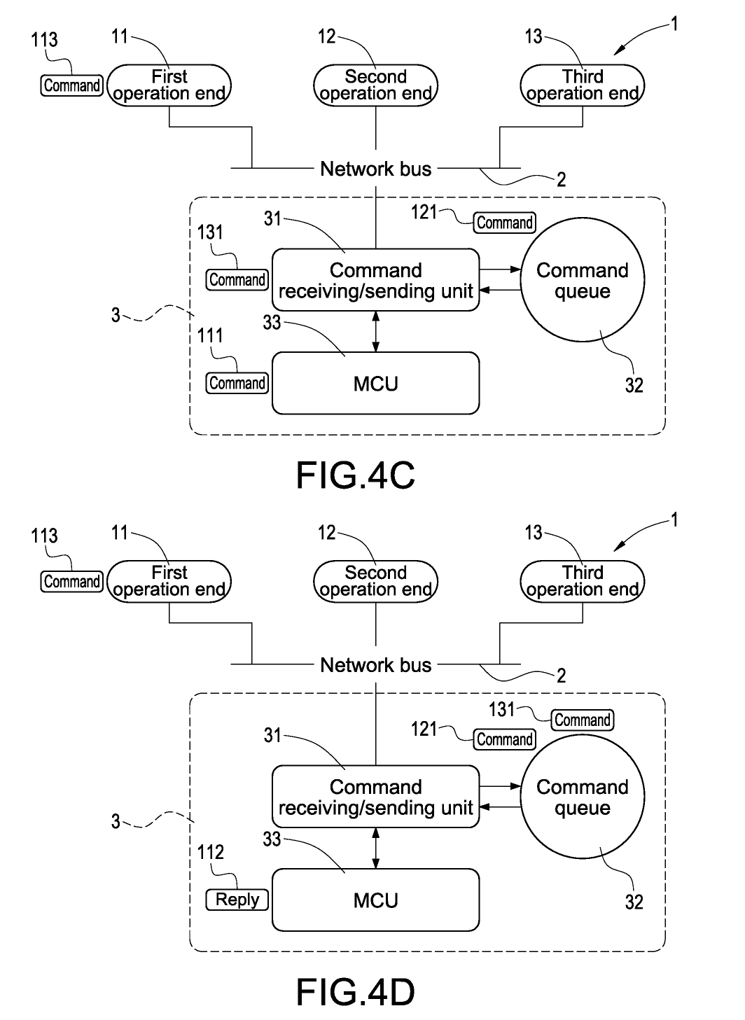

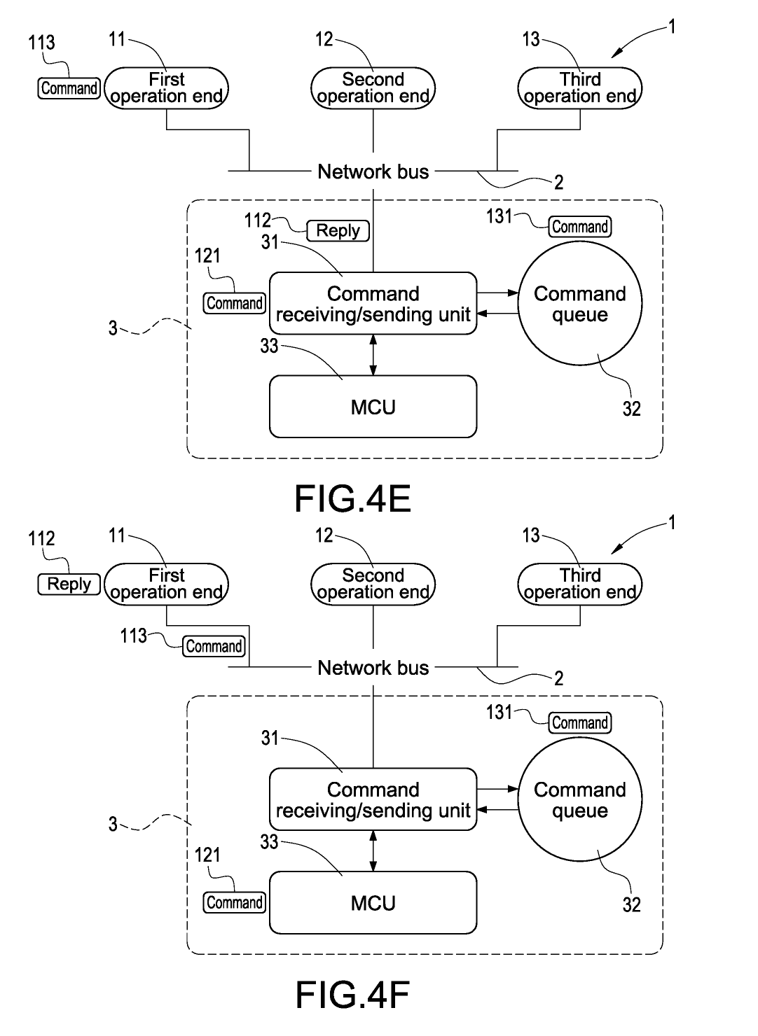

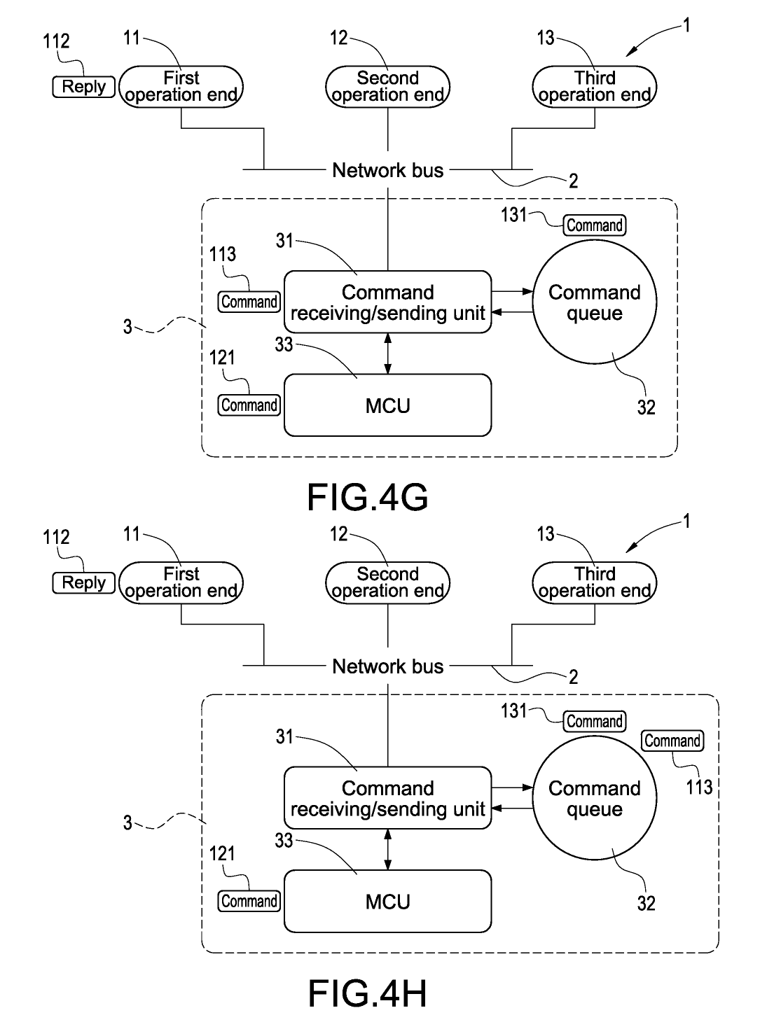

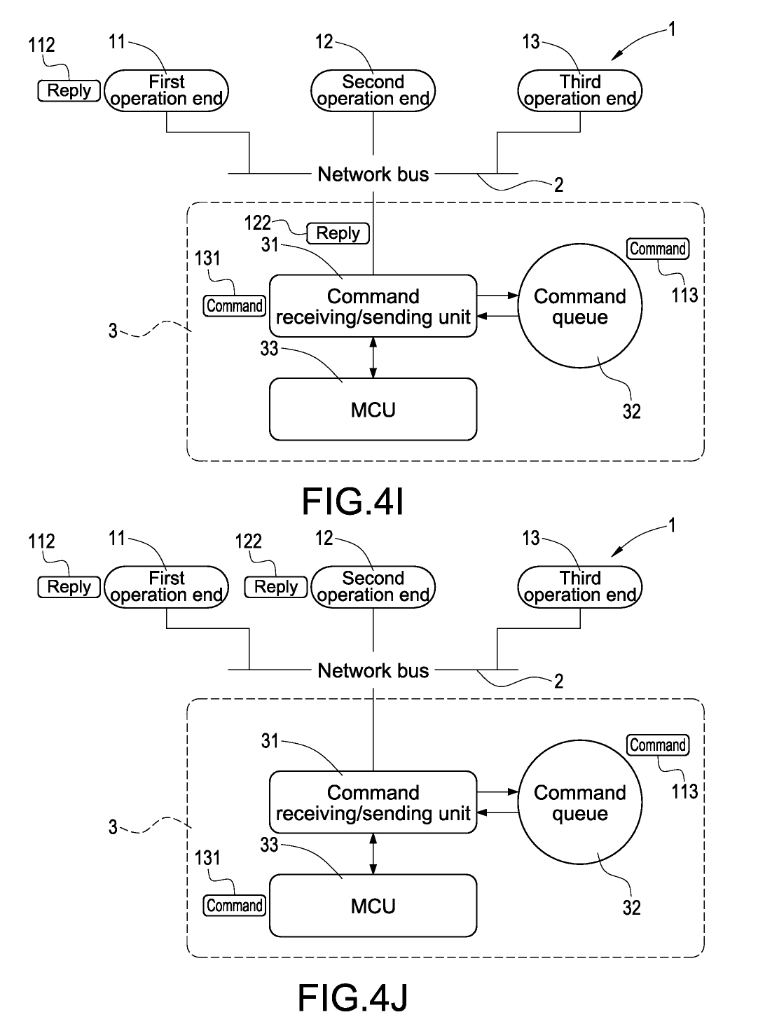

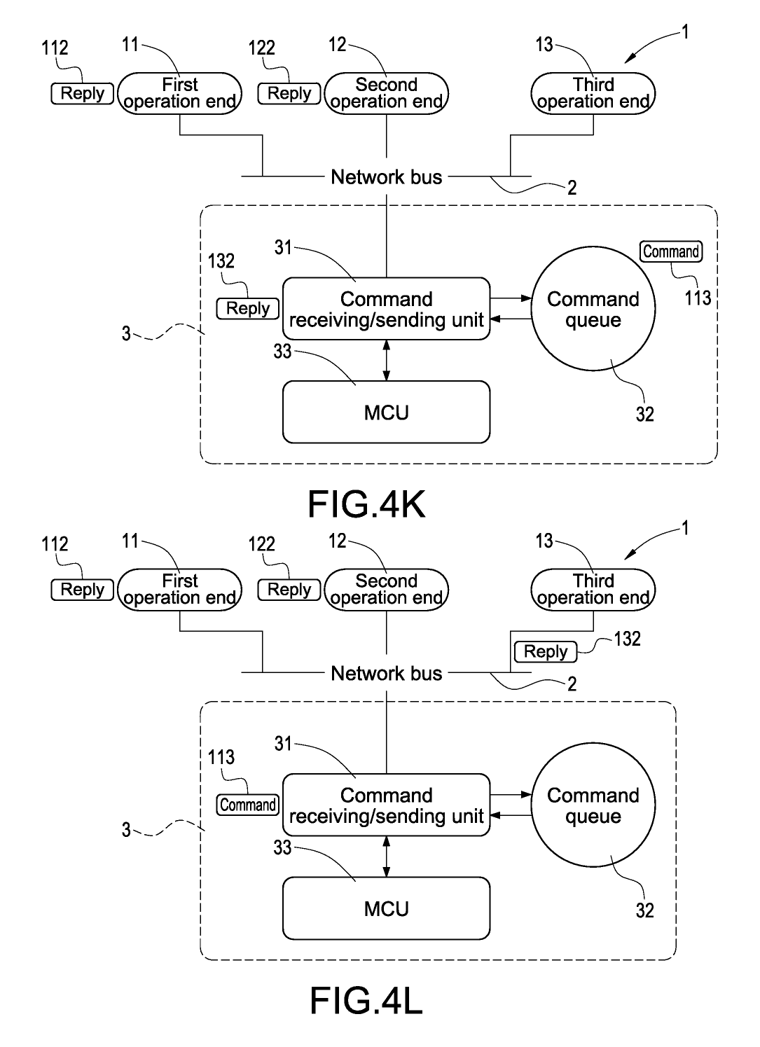

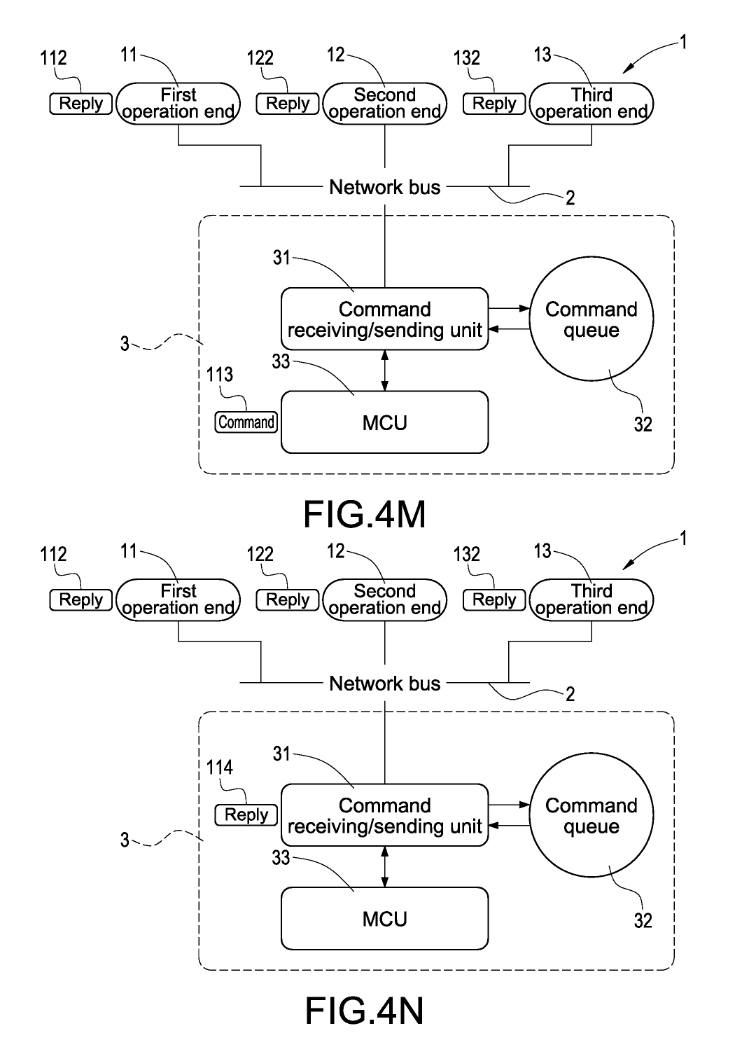

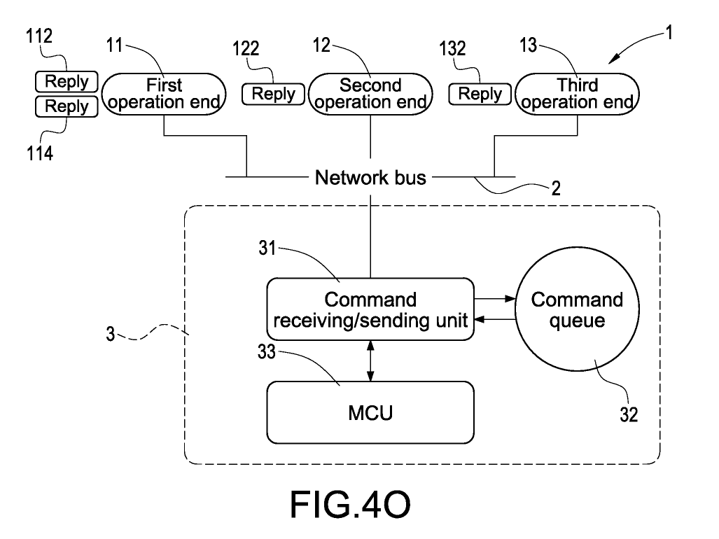

With reference to FIGS. 4A to 4O, the operations of the method of providing queue function for PLC according to the present invention are demonstrated. There are three operation ends 11, 12, and 13 accessing the PLC 3 through the network bus 2. By the method of providing queue function for PLC according to the present invention, the commands send from the operation ends 11, 12, and 13 for accessing the PLC can be processed fairly and correctly without negligence.

When the first command 111, the second command 121 and the third commands 131 are sequentially sent by the operation ends 11, 12, and 13, the command receiving/sending unit 31 also receives the first command 111, the second command 121 and the third command 131 sequentially. The command receiving/sending unit 31 sends the first command 111 to the MCU 33 for processing and then sends the second command 121 and the third command 131 to the command queue 32 as shown in FIG. 4D.

After the MCU 33 finishes processing the first command 111, the MCU 33 sends back a first reply 112 to the first operation end 11 to reply the first command 111. Afterward, the second command 121 is fetched from the command queue 32 and sent to the MCU 33 through the command receiving/sending unit 31. At this time, the first operation end 11 has received the first reply 112 and then sends the fourth command 113. When the command receiving/sending unit 31 receives the fourth command 113, the command receiving/sending unit 31 stores the fourth command 113 in the command queue 32 because the MCU is processing the second command 121 at that moment, as shown in FIG. 4H.

After the second command 121 is processed, the second reply 122 is sent to the second operation end 12. The third command 131 is fetched from the command queue 32 and then sent to the MCU 33 through the command receiving/sending unit 31. After the third command 131 is processed, the third reply 132 is sent to the third operation end 13. Afterward, the fourth command 113 is fetched from the command queue 32 and then sent to the MCU 33 through the command receiving/sending unit 31. After the fourth command 113 is processed, the third reply 132 is sent to the third operation end 13. In this way, all of the operation ends 11, 12 and 13 can get replies from the PLC 3 successfully.

As can be seen from above description, the PLC with queue function and method for providing the queue function according to the present invention enable multiple operation ends to access a PLC simultaneously. This provides

Although the present invention has been described with reference to the preferred embodiment thereof, it will be understood that the invention is not limited to the details thereof. Various substitutions and modifications have suggested in the foregoing description, and other will occur to those of ordinary skill in the art. Therefore, all such substitutions and modifications are intended to be embraced within the scope of the invention as defined in the appended claims.

What is claimed is:

1. A method for providing queue function in programmable logic controller (PLC) accessed by a plurality of operation ends, comprising:
a) receiving an input command from one of the operation ends and judging whether the PLC is processing any command;
b) processing the input command when the PLC is not processing any command;
c) storing the input command in a command queue when the PLC is processing another command; and
d) fetching a command with highest processing priority after the PLC finishes process.

2. The method as in claim 1, wherein the command with highest processing priority is a command at first position in command queue.

3. The method as in claim 1, further comprising:
sending a reply associated with a command to the operation end sending the command.

4. The method as in claim 1, further comprising:
providing a network bus to connect the PLC and the operation ends.

5. A programmable logic controller (PLC) having queue function and connected to a plurality of operation ends through a network bus, comprising:
a command receiving/sending unit electrically connected to the network bus, the command receiving/sending unit receiving commands from the operation ends and sending replies to the operation ends;
a command queue electrically connected to the command receiving/sending unit and storing un-processed commands; and
a micro controller unit electrically connected to the command receiving/sending unit, the micro controller unit processing the commands sent from the operation ends and sending replies to the operation ends corresponding to the processed commands.
